(19) United States
(12) Patent Application Publication
(10) Pub. No.: US 2025/0289097 A1
(43) Pub. Date: Sep. 18, 2025

(54) VACUUM-MOUNT TOOLS AND METHODS OF UTILIZING VACUUM-MOUNT TOOLS

(71) Applicant: The Boeing Company, Arlington, VA (US)

(72) Inventors: Matthew H. Mellin, Seattle, WA (US); Mark P. Johnson, Snohomish, WA (US); Scott A. Adams, Everett, WA (US); Collins S. Davis, Shoreline, WA (US)

(21) Appl. No.: 18/608,638

(22) Filed: Mar. 18, 2024

(51) Int. Cl. B25B 11/00

(52) U.S. Cl. CPC B25B 11/005

(57) ABSTRACT

Vacuum-mount tools and methods of performing a device operation on a surface utilizing the vacuum-mount tools are disclosed herein. The vacuum-mount tools include an enclosure that defines an enclosure opening. The vacuum-mount tools also include a sealing structure that defines a surface-contacting seal such that, when the surface-contacting seal is brought into sealing engagement with the surface, the surface covers the enclosure opening such that the enclosure, the sealing structure, and the surface together define an enclosed volume. The vacuum-mount tools also include a vacuum inlet port that is configured to receive an applied vacuum that selectively urges the vacuum-mount tool toward the surface via a pressure force generated by evacuation of the enclosed volume. The vacuum-mount tools further include a device mount configured to retain a device within the enclosed volume. The device is configured to perform the device operation on the surface via the enclosure opening.

### FIELD

The present disclosure relates generally to vacuum-mount tools and to methods of utilizing vacuum-mount tools.

### BACKGROUND

Conventional devices, such as conventional sanding devices, laser ablation devices, cleaning devices, printing devices, inspection devices, and/or painting devices, may be utilized to perform one or more device operations, such as sanding, laser ablation, cleaning, printing, inspecting, and/or painting, on a surface. For some surfaces, performing the device operations may be time-consuming, tedious, and/or ergonomically challenging for an operator of the device. In such circumstances, it may be desirable to improve the overall ergonomics of the device operation and/or to automate the device operation. In some examples, the device operation may generate debris. In such circumstances, it may be desirable to contain and/or to collect the debris. In some examples, the device operation may utilize materials and/or energies that may be hazardous to the operator. In such circumstances, it may be desirable to contain these materials and/or energies and/or to ensure separation between the operator and these materials and/or energies. Conventional devices may be ineffective at meeting all of these needs. Thus, there exists a need for improved vacuum-mount tools and for improved methods of performing a device operation on a surface utilizing a device.

### SUMMARY

Vacuum-mount tools and methods of utilizing vacuum-mount tools are disclosed herein. The vacuum-mount tools include an enclosure that defines an enclosure opening. The vacuum-mount tools also include a sealing structure that defines a surface-contacting seal. The sealing structure is operatively attached to the enclosure such that, when the surface-contacting seal is brought into sealing engagement with the surface, the surface covers the enclosure opening such that the enclosure, the sealing structure, and the surface together define an enclosed volume. The vacuum-mount tools also include a vacuum inlet port that extends from external the enclosure into the enclosed volume. The vacuum inlet port is configured to receive an applied vacuum that selectively urges the vacuum-mount tool toward the surface via a pressure force generated by evacuation of the enclosed volume. The vacuum-mount tools further include a device mount positioned within the enclosed volume and configured to retain a device within the enclosed volume. The device is configured to perform the device operation on the surface via the enclosure opening.

The methods include positioning a vacuum-mount tool, which includes the device, on the surface. The vacuum-mount tool includes an enclosure that defines an enclosed volume, the device is positioned at least partially within the enclosed volume, and the positioning includes forming an at least partial fluid seal between the surface and a sealing structure of the device. The methods also include applying an applied vacuum to the enclosed volume to at least partially evacuate the enclosed volume and generate a pressure force that urges the vacuum-mount tool toward the surface. The methods further include performing the device operation on the surface with the device and while the pressure force urges the vacuum-mount tool toward the surface.

### BRIEF DESCRIPTION OF THE DRAWINGS

FIG. 1 is a schematic illustration of examples of a vacuum-mount tool according to the present disclosure.

FIG. 2 is a profile view of an example of a vacuum-mount tool according to the present disclosure.

FIG. 3 is a side view of the vacuum-mount tool of FIG. 2.

FIG. 4 is a top view of the vacuum-mount tool of FIGS. 2-3.

FIG. 5 is a bottom view of the vacuum-mount tool of FIGS. 2-4.

FIG. 6 is a cross-sectional view of the vacuum-mount tool of FIGS. 2-5.

FIG. 7 is a flowchart depicting examples of methods of utilizing a vacuum-mount tool to perform a device operation on a surface, according to the present disclosure.

### DESCRIPTION

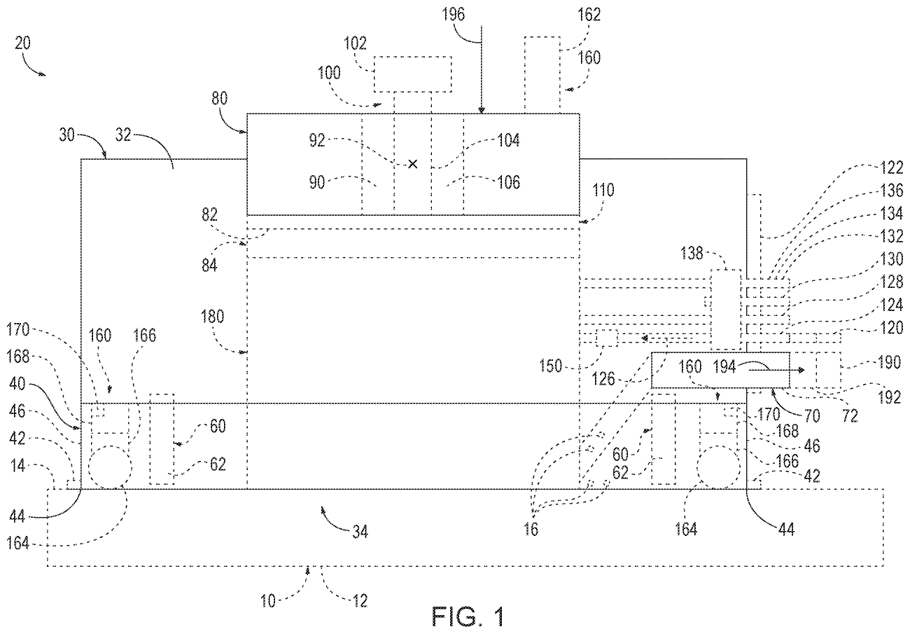

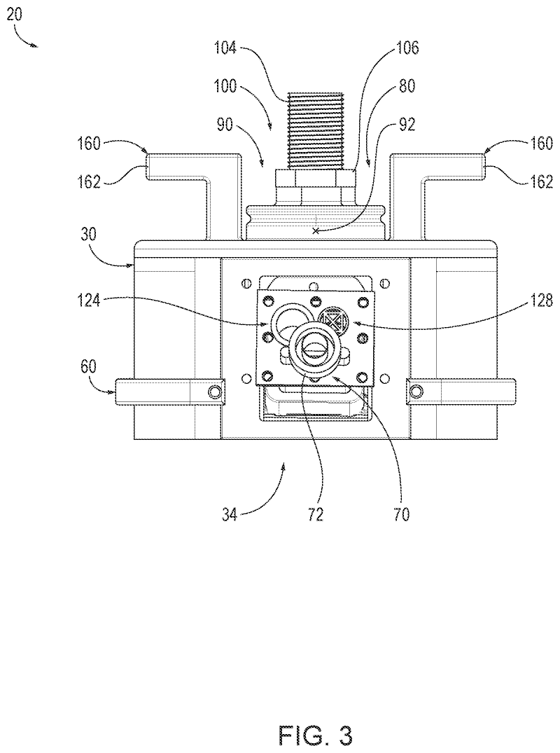

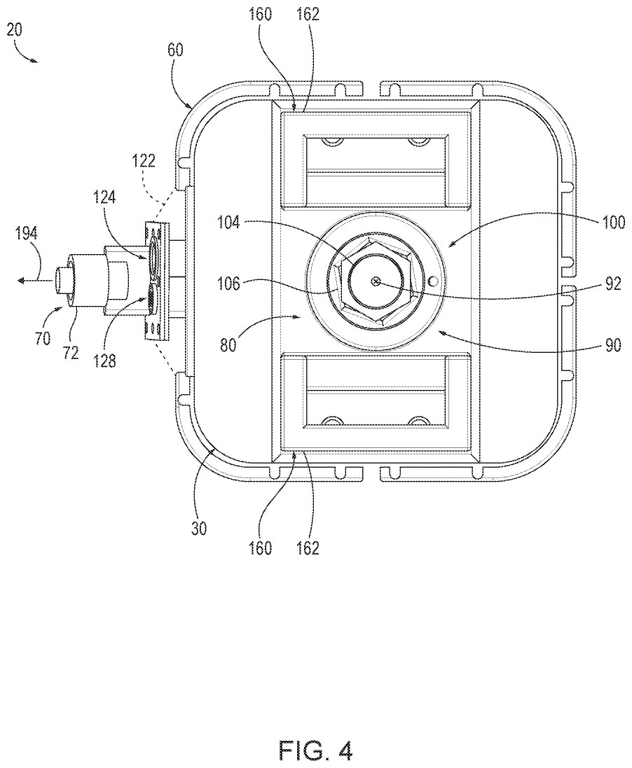

FIGS. 1-7 provide illustrative, non-exclusive examples of vacuum-mount tools 20 and/or of methods 200, according to the present disclosure. Elements that serve a similar, or at least substantially similar, purpose are labeled with like numbers in each of FIGS. 1-7, and these elements may not be discussed in detail herein with reference to each of FIGS. 1-7. Similarly, all elements may not be labeled in each of FIGS. 1-7, but reference numerals associated therewith may be utilized herein for consistency. Elements, components, and/or features that are discussed herein with reference to one or more of FIGS. 1-7 may be included in and/or utilized with any of FIGS. 1-7 without departing from the scope of the present disclosure.

In general, elements that are likely to be included in a given (i.e., a particular) embodiment are illustrated in solid lines, while elements that may be optional to a given embodiment are illustrated in dashed lines. However, elements that are shown in solid lines are not essential to all embodiments, and an element shown in solid lines may be omitted from a particular embodiment without departing from the scope of the present disclosure.

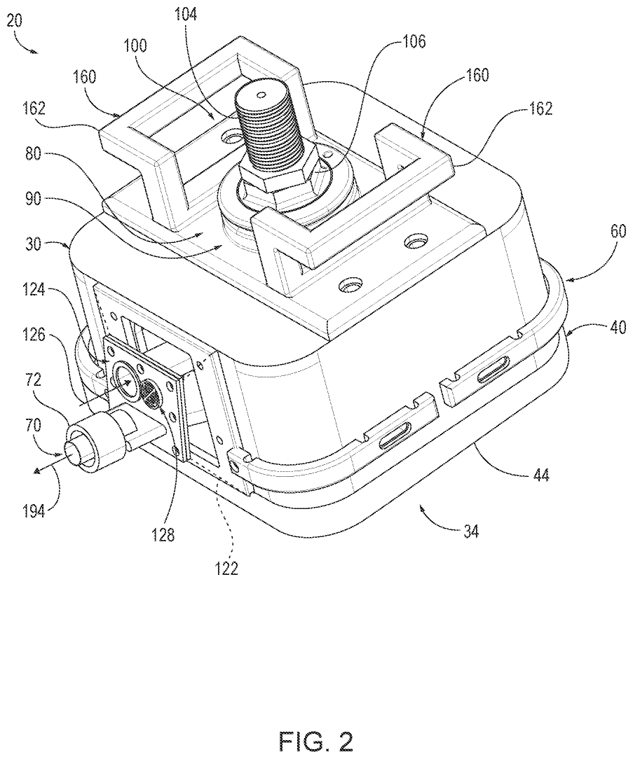

FIG. 1 is a schematic illustration of examples of a vacuum-mount tool 20 according to the present disclosure, and FIGS. 2-6 are various views of an example of a vacuum-mount tool 20 according to the present disclosure. As collectively illustrated by FIGS. 1-6, vacuum-mount tools 20, which also may be referred to herein as tools 20, include an enclosure 30, a sealing structure 40, a vacuum inlet port 70, and a device mount 80.

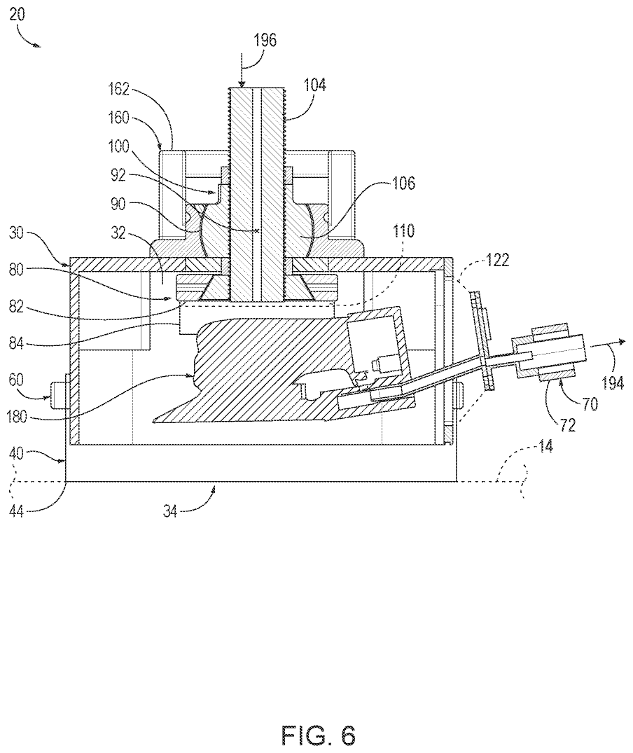

As perhaps best illustrated in FIGS. 1 and 5-6, enclosure 30 defines an enclosure opening 34. As perhaps best illustrated in FIGS. 1 and 6, sealing structure 40 defines a surface-contacting seal 44. In addition, sealing structure 40 is operatively attached to enclosure 30 such that, when surface-contacting seal 44 is brought into sealing engagement with a surface 14, surface 14 covers enclosure opening 34 such that enclosure 30, sealing structure 40 and surface 14 together define, at least partially define, bound, and/or at least partially bound an enclosed volume 32. Vacuum inlet port 70 extends from external enclosure 30 into enclosed volume 32 and is configured to receive an applied vacuum 194. Receipt of applied vacuum 194 selectively and/or urges vacuum-mount tool 20 toward surface 14 via a pressure force 196, which is generated by and/or responsive to evacuation, or at least partial evacuation, of enclosed volume 32, as perhaps best illustrated in FIGS. 1 and 6. Device mount 80 is positioned within enclosed volume 32 and is configured to retain a device 180 within enclosed volume 32, as also illustrated in FIGS. 1 and 6. Device 180 is configured to perform a device operation on surface 14 via, or with access through, enclosure opening 34.

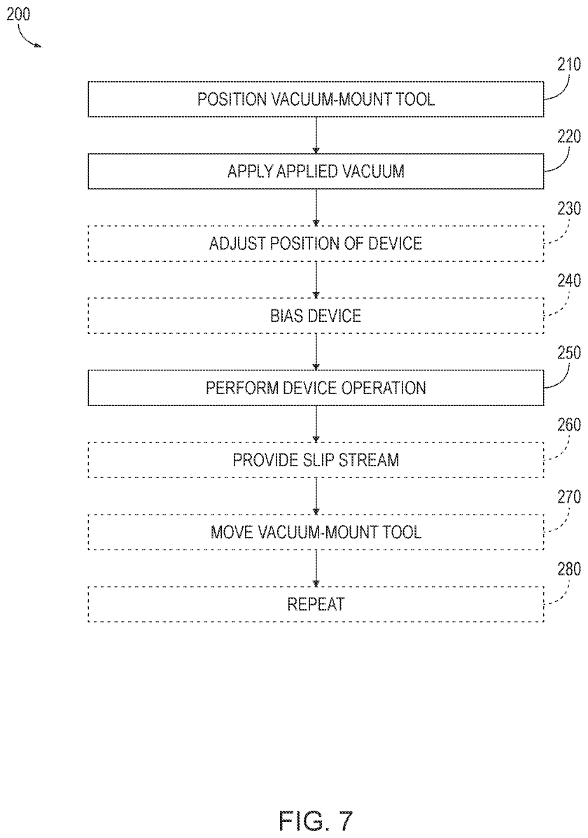

During operation of vacuum-mount tool 20, and as discussed in more detail herein with reference to methods 200 of FIG. 7, vacuum-mount tool 20 may be positioned on surface 14, as illustrated in FIGS. 1 and 6. Upon being positioned on surface 14, sealing structure 40 and/or surface-contacting seal 44 of vacuum-mount tool 20 may form an at least partial fluid seal with surface 14. Stated differently, and upon being positioned on surface 14, vacuum-mount tool 20 and surface 14 together may define and/or bound enclosed volume 32. Applied vacuum 194 then may be applied to enclosed volume 32 to at least partially evacuate the enclosed volume. Evacuation of the enclosed volume generates pressure force 196, which presses and/or urges vacuum-mount tool 20 toward and/or onto surface 14 and/or that attaches vacuum-mount tool 20 to surface 14. Device 180 then may be utilized to perform a device operation on surface 14 while applied vacuum 194 is applied to enclosed volume 32 and/or while pressure force 196 urges vacuum-mount tool 20 toward surface 14.

As discussed in more detail herein, such a configuration may permit and/or facilitate improved operation of device 180. As an example, retention of vacuum-mount tool 20 on surface 14 via pressure force 196 may decrease operator fatigue and/or may improve ergonomics for an operator who utilizes vacuum-mount tool 20 to perform the device operation. As another example, vacuum-mounted tool may be moved across surface 14 in an automated and/or automatic fashion while pressure force 196 retains vacuum-mounted tool 20 on surface 14. As yet another example, waste material 16, such as debris, generated by performing the device operation may be contained within enclosed volume 32 and/or may be removed from enclosed volume 32 via applied vacuum 194. As another example, vacuum-mount tool 20 may retain materials and/or energies, which may be hazardous to the operator, within enclosed volume 32, thereby increasing operator safety.

Enclosure 30 may include any suitable structure that defines enclosure opening 34, that at least partially bounds and/or defines enclosed volume 32, that may be operatively attached to device 180, such as via device mount 80, that may be operatively attached to and/or may define sealing structure 40, and/or that may permit and/or facilitate extension of vacuum inlet port 70 from external enclosure 30 and into enclosed volume 32. Examples of enclosure 30 include any suitable wall, panel, container, membrane, sheet of material, fluid-impermeable barrier, at least partially fluid-impermeable barrier, gas-impermeable barrier, and/or at least partially gas-impermeable barrier.

In some examples, enclosure 30 may be shaped and/or sized to bound a majority of enclosed volume 32. As examples, enclosure 30 may bound and/or define at least 50%, at least 60%, at least 70%, at least 80, or at least 90% of enclosed volume 32 or of an external periphery of enclosed volume 32.

Enclosure 30 may have and/or define any suitable shape. As an example, enclosure 30 may be shaped to bound, or to at least partially bound, five sides of enclosed volume 32. As another example, enclosure 30 may be shaped to bound, or to at least partially bound, all but one side of enclosed volume 32. Similarly, enclosed volume 32 may have and/or define any suitable shape. As an example, surface 14, enclosure 30, and sealing structure 40 together may define a rectangular, an at least partially rectangular, an at least partially circular, a cylindrical, an at least partially cylindrical, and/or an at least partially elliptical enclosed volume 32 when sealing structure 40 is brought into sealing engagement with surface 14.

Sealing structure 40 may include any suitable structure that may be operatively attached to enclosure 30, that may define a fluid-impermeable, an at least partially fluid-impermeable, or an at least substantially fluid-impermeable interface with enclosure 30, that includes surface-contacting seal 44, and/or that is configured to sealingly engage with surface 14. Examples of sealing structure 40 include an elastomeric sealing structure, a resilient sealing structure, and/or a polymeric sealing structure. Another example of sealing structure 40 includes a resilient sealing skirt 46, as illustrated in FIG. 1. Resilient sealing skirt 46 may extend from enclosure opening 34, may be configured to contact surface 14, may be configured to conform to a surface shape of surface 14, and/or may be configured to form surface-contacting seal 44 with surface 14. Another example of sealing structure 40 includes a resilient sealing lip 42, as illustrated in FIG. 1. Resilient sealing lip 42 may extend from resilient sealing skirt 46, may extend from enclosure opening 34, may be configured to contact surface 14, may be configured to conform to the surface shape of surface 14, and/or may be configured to form surface-contacting seal 44 with surface 14.

In some examples, vacuum-mount tool 20 may include a sealing structure support frame 60. Sealing structure support frame 60, when present, may be configured to support sealing structure 40 relative to enclosure 30 and/or to attach sealing structure 40 to enclosure 30. In some examples, and as illustrated in FIG. 1, sealing structure support frame 60 may include and/or be a plurality of support frame biasing members 62, which may be configured to bias surface-contacting seal 44 away from enclosure opening 34. Examples of support frame biasing members 62 include resilient support frame biasing members and/or support frame biasing springs. In some examples, each support frame biasing member 62 may be configured to independently bias a corresponding region of sealing structure 40 away from enclosure opening 34, such as to permit surface-contacting seal 44 to conform to the surface shape of surface 14.

Vacuum inlet port 70 may include any suitable structure that may be adapted, configured, designed, and/or constructed to extend from external enclosure 30 and into enclosed volume 32 and/or to receive applied vacuum 194. An example of vacuum inlet port 70 includes a vacuum inlet tube, a vacuum inlet tubular, and/or a vacuum inlet conduit. In some examples, vacuum inlet port 70 may include a vacuum conduit mount 72. Vacuum conduit mount 72 may be configured to be operatively attached to a vacuum conduit 192, which may be configured to provide applied vacuum 194. In some such examples, vacuum-mount tool 20 further may include a vacuum source 190, which may be configured to provide applied vacuum 194 to enclosed volume 32, such as via vacuum inlet port 70 and/or vacuum conduit 192. Examples of vacuum source 190 include a vacuum pump, a gas transfer pump, a kinetic transfer pump, a positive displacement pump, and/or an entrapment pump.

In some examples, and as discussed, vacuum inlet port 70 may be configured to receive waste material 16 from enclosed volume. Stated differently, performance of the device operation with device 180 may produce and/or generate waste material 16, which may be discharged from enclosed volume 32 via vacuum inlet port 70 and/or within applied vacuum 194. Examples of waste material 16 include a liquid waste material, a solid waste material, and/or a particulate waste material. In a specific example, waste material 16 may include debris generated from surface 14 during and/or via the device operation.

Device mount 80 may include any suitable structure that may be adapted, configured, designed, and/or constructed to be positioned at least partially within enclosed volume 32, to retain device 180 within enclosed volume 32, to provide a defined and/or desired relative orientation between device 180 and enclosure opening 34, and/or to permit and/or facilitate performance of the device operation by device 180, on surface 14, and/or via enclosure opening 34. In some examples, device mount 80 may include and/or be a modular device mount 80, which may be configured to retain a plurality of different devices 180 within enclosed volume 32. In some such examples, each different device 180 may be configured to perform a different device operation on surface 14. Also in some such examples, modular device mount 80 may include a device adapter 84, which may be configured to be operatively attached to a corresponding device 180 of the plurality of devices 180. In some such examples, modular device mount 80 also may include an adapter mount 82, which may be configured to operatively attach device adapter 84 to enclosure 30 and/or to a remainder of modular device mount 80. In such examples, vacuum-mount tool 20 may include a plurality of distinct, or differently shaped, device adapters 84, each of which may be configured to be operatively attached to a different corresponding device 180 and/or to operatively attach the different corresponding device to adapter mount 82.

Examples of device adapter 84 include any suitable spacer and/or fastener that may be configured to interface both with the corresponding device 180 and adapter mount 82 and/or to adapt adapter mount 82 to the corresponding device 180. Examples of adapter mount 82 include any suitable mounting plate, fixture, and/or fastener that may be configured to be operatively attached to the plurality of distinct device adapters 84.

As illustrated in dashed lines in FIG. 1 and in solid lines in FIGS. 2-4 and 6, device mount 80 may include and/or be a pivot structure 90. Pivot structure 90 may be configured to permit device 180 to pivot, such as about a pivot point 92, relative to enclosure 30 and/or within enclosed volume 32. An example of pivot structure 90 includes a spherical, or an at least partially spherical, bearing. Pivot structure 90 may operatively attach at least one other component of device mount 80, or even a remainder of device mount 80, to enclosure 30. Stated differently, pivot structure 90 may permit device 180 to pivot relative to enclosure 30 and/or about pivot point 92.

As illustrated in dashed lines in FIG. 1 and in solid lines in FIGS. 2-4 and 6, device mount 80 may include a height adjustment structure 100, which may be configured to operatively translate device 180 within enclosed volume 32, relative to enclosure opening 34, and/or in a direction that is perpendicular, or at least substantially perpendicular, to surface 14 when vacuum-mount tool 20 is positioned on surface 14. Stated differently, height adjustment structure 100 may be configured to selectively adjust a position of device 180 relative to enclosure opening 34. Such a configuration may permit device 180 to perform the device operation on surface 14 with a desired distance between device 180 and surface 14 and/or with a desired normal force applied to surface 14 by device 180.

In some examples, and as illustrated in FIG. 1, height adjustment structure 100 may include a height adjustment handle 102. Height adjustment handle 102 may be positioned external enclosed volume 32 and/or may be configured to be actuated, or rotated, to selectively adjust the position of device 180 relative to enclosure opening 34.

In a more specific example, height adjustment structure 100 may include a threaded post 104 and a threaded nut 106. In such a configuration, threaded post 104 may be configured to be operatively attached to device 180 and/or to adapter mount 82. Stated differently, threaded post 104 may be configured to operatively attach device 180 to a remainder of vacuum-mount tool 20, such as to enclosure 30. Threaded post 104 may be operatively attached to the remainder of vacuum-mount tool 20 via threaded nut 106 and/or may be configured to be rotated to operatively translate device 180 relative to enclosure opening 34.

In some examples, and as perhaps best illustrated in FIGS. 1 and 6, threaded nut 106 may at least partially define, may be at least partially defined by, and/or may be operatively attached to pivot structure 90. As an example, threads of threaded nut 106 may be defined within pivot structure 90 and/or within the spherical bearing of pivot structure 90. In such configurations, pivot point 92 may be within threaded nut 106.

As illustrated in dashed lines in FIG. 1, device mount 80 may include a device biasing structure 110. In some such examples, height adjustment structure 100 may include and/or may be at least partially, or even completely, defined by device biasing structure 110. Device biasing structure 110 may be configured to bias device 180, adapter mount 82, and/or device adapter 84 toward and/or into enclosure opening 34. In some such examples, device biasing structure 110 may be configured to be actuated, or selectively actuated, to selectively bias device 180 toward and/or into enclosure opening 34. Examples of device biasing structure 110 include a resilient biasing member, an air bearing, a hydraulic cylinder, and/or a pneumatic cylinder.

In some examples, device biasing structure 110 may be configured to produce, to generate, and/or to provide a constant, or at least substantially constant, contact force between device 180 and surface 14. As an example, when device biasing structure 110 includes the hydraulic cylinder and/or the pneumatic cylinder, application of a constant, or at least substantially constant, hydraulic and/or pneumatic pressure may cause device biasing structure 110 to provide the constant, or at least substantially constant, contact force. This contact force may be constant even when a position of device 180 within enclosed volume 32 varies, such as may be caused by variations in the shape of surface 14 as vacuum-mount tool 20 is moved across surface 14. Such a configuration may permit and/or facilitate consistent performance of contact force-dependent device operations by device 180.

In some examples, device 180 may include and/or be a powered device 180, which may be configured to perform the device operation on the surface responsive to receipt of a motive input 126, as illustrated in dashed lines in FIG. 1 and in solid lines in FIG. 2. Examples of motive input 126 include an electric motive input, a pneumatic motive input, and/or a hydraulic motive input.

As illustrated in dashed lines in FIG. 1 and in solid lines in FIGS. 2-4, and in some such examples, vacuum-mount tool 20 may include a motive input supply structure 124, which may be configured to receive motive input 126 from external enclosed volume 32, to convey motive input 126 into enclosed volume 32, and/or to provide motive input 126 to device 180. Examples of motive input supply structure 124 include an electrical conduit and/or a fluid conduit.

Motive input supply structure 124 may be configured to maintain a fixed, or at least substantially fixed, orientation relative to device 180 and/or to device mount 80 when device mount 80 pivots relative to enclosure 30, such as about pivot point 92. As an example, and as illustrated in dashed lines in FIGS. 1-2 and 4-6, motive input supply structure 124 may be operatively attached to enclosure 30 via a resilient supply attachment structure 122. Resilient supply attachment structure 122 may be configured to flex and/or deform, such as to permit motive input supply structure 124 to pivot relative to enclosure 30 and/or about pivot point 92. Examples of resilient supply attachment structure 122 are disclosed herein with reference to resilient sealing skirt 46.

As illustrated in dashed lines in FIG. 1 and in solid lines in FIGS. 2-4, vacuum-mount tool 20 also may include a motive input discharge structure 128. Motive input discharge structure 128 may be configured to receive motive input 126 from device 180, to convey motive input 126 external enclosed volume 32, and/or to discharge motive input 126 from enclosed volume 32. An example of motive input discharge structure 128 includes a motive input discharge fluid conduit, which may extend from device 180 to external enclosed volume 32. When motive input 126 includes the pneumatic motive input and/or the hydraulic motive input, such a configuration may permit and/or facilitate utilizing of the motive input while maintaining evacuation of enclosed volume 32 via applied vacuum 194, as discussed in more detail herein. In some examples, motive input discharge structure 128 may be operatively attached to enclosure 30 via resilient supply attachment structure 122. Such a configuration may permit motive input discharge structure 128 to pivot with device 180 and/or about pivot point 92.

As illustrated in dashed lines in FIG. 1, vacuum-mount tool 20 may include a motive input source 120, which may be configured to provide motive input 126 to motive input supply structure 124. Examples of motive input source 120 include an electric current source, a voltage source, a pressurized fluid source, a pressurized air source, a pressurized gas source, and/or a pressurized liquid source.

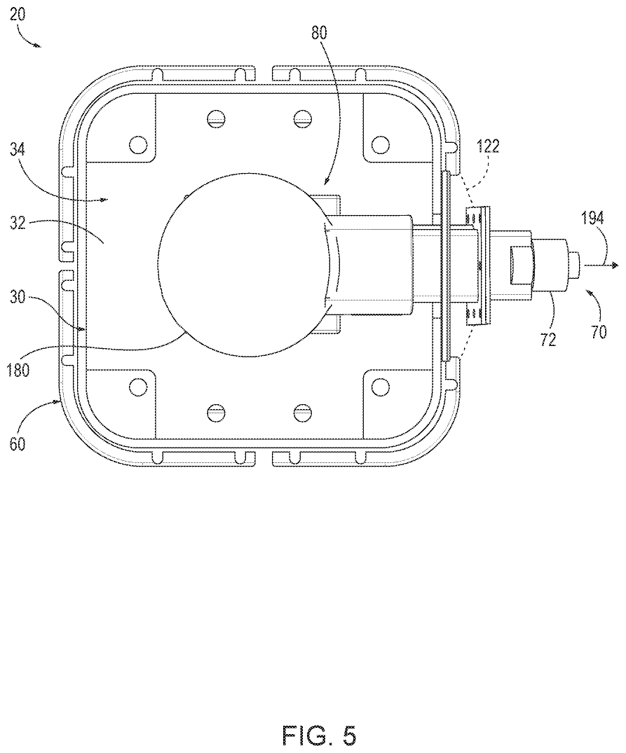

As illustrated in dashed lines in FIG. 1 and in solid lines in FIGS. 5-6, vacuum-mount tool 20 may include device 180. Device 180 may include any suitable structure that may be adapted, configured, designed, and/or constructed to be positioned within enclosed volume 32, to be operatively attached to device mount 80, and/or to perform the device operation on surface 14. Examples of device 180 include a sanding device, a laser ablation device, a cleaning device, a printing device, an inspection device, and/or a painting device.

When device 180 includes the sanding device, the sanding device may be configured to perform the device operation, in the form of a sanding operation, on surface 14. In such a configuration, enclosure 30 and/or enclosed volume 32 may be configured to contain, or at least temporarily contain, waste materials 16, such as debris, generated during and/or by the sanding operation. Also in such a configuration, vacuum-mount tool 20 may be configured to discharge the debris from enclosure 30 and/or from enclosed volume 32 via vacuum inlet port 70 and/or within applied vacuum 194 that is applied to vacuum inlet port 70. In some examples, the sanding device may include and/or be a pneumatically powered sanding device, which may be configured to receive motive input 126 in the form of the compressed air stream. Such a configuration may permit vacuum-mount tool 20 to be, or to be entirely, pneumatically and/or vacuum-powered. This may decrease a potential for ignition of debris generated by the sanding operation when compared to configurations in which device 180 is electrically powered.

When device 180 includes the laser ablation device, the laser ablation device may be configured to direct a laser beam incident upon surface 14 and/or to perform the device operation, in the form of a laser ablation operation, on the surface and/or utilizing the laser beam. In such a configuration, enclosure 30 and/or enclosed volume 32 may be configured to contain, or at least temporarily contain, waste materials 16, such as debris, generated during and/or by the laser ablation operation. Also in such a configuration, vacuum-mount tool 20 may be configured to discharge the debris from enclosure 30 and/or from enclosed volume 32 via vacuum inlet port 70 and/or within applied vacuum 194 that is applied to vacuum inlet port 70. Stated differently, applied vacuum 194 may be sufficient to remove the debris, to prevent the debris from escaping enclosed volume 32 and/or to prevent light from the laser ablation device from escaping enclosed volume 32.

In some such examples, vacuum-mount tool 20 may include a compressed air inlet port 132, as illustrated in FIG. 1. Compressed air inlet port 132 may be configured to direct a compressed air stream between the laser and the surface and/or along a beam path of the laser beam, such as to remove debris from the beam path of the laser beam.

In some such examples, vacuum-mount tool 20 may include a vacuum detection structure 150, as illustrated in FIG. 1. Vacuum detection structure 150 may be configured to cease operation of device 180, such as to cease emission of the laser beam from the laser, responsive to a pressure within enclosed volume 32 being greater than a threshold pressure, such as may be indicative of a lack of sealing engagement between sealing structure 40 and surface 14. Such a configuration may improve safety of vacuum-mounted tools 20 and/or may decrease a potential for the laser beam to exit enclosed volume 32. As an example, enclosure 30, sealing structure 40, and surface 14 all may be opaque to the laser beam. As such, and when the pressure is less than the threshold pressure, the laser beam is, or must be, contained within enclosed volume 32. However, when the pressure is greater than the threshold pressure, there may be a potential for the laser beam to escape from the enclosed volume, such as via enclosure opening 34 and/or via a gap between sealing structure 40 and surface 14.

When device 180 includes the cleaning device, the cleaning device may be configured to perform the device operation, in the form of a cleaning operation, on surface 14. As an example, the cleaning device may be configured to direct a water stream incident upon surface 14. In such a configuration, vacuum-mount tool 20 may include a water inlet port 134, as illustrated in FIG. 1, which may be configured to convey the water stream into the enclosed volume and/or incident upon surface 14. Also in such a configuration, vacuum-mount tool 20 may be configured to discharge the water stream from enclosed volume 32 via vacuum inlet port 70 and/or within applied vacuum 194 that is applied to vacuum inlet port 70.

When device 180 includes the printing device, the printing device may be configured to perform the device operation, in the form of a printing operation, on surface 14. As an example, the printing device may be configured to apply ink to surface 14. An example of the printing device includes an inkjet printer.

When device 180 includes the inspection device, the inspection device may be configured to perform the device operation, in the form of an inspection operation, on surface 14. In such a configuration, enclosed volume 32 may form and/or define a protected environment that may shield the inspection device from an ambient environment that surrounds vacuum-mount tool 20 and/or may contain materials and/or energies utilized by and/or emitted from the inspection device.

When device 180 includes the painting device, the painting device may be configured to perform the device operation, in the form of a painting operation, on surface 14. Stated differently, the painting device may be configured to paint surface 14. In such a configuration, vacuum-mount tool 20 may include a paint inlet port 136, as illustrated in FIG. 1, which may be configured to convey a paint stream into the enclosed volume and/or incident upon surface 14.

As illustrated in dashed lines in FIG. 1, vacuum-mount tool may include a slip stream inlet port 130. Slip stream inlet port 130 may be configured to provide a slip stream into enclosed volume 32. Examples of the slip stream include a gas, a compressed gas, compressed air, and/or ambient air. In some examples, such as when the slip stream differs from motive input 126, slip stream inlet port 130 may be distinct from motive input supply structure 124. In some examples, such as when the slip stream is similar to motive input 126 and/or the slip stream and motive input 126 both include air, slip stream inlet port 130 may include and/or be motive input supply structure 124. Supply of the slip stream into enclosed volume 32 may increase the pressure within the enclosed volume, thereby permitting and/or facilitating motion of vacuum-mount tool 20 across surface 14. In some examples, a flow rate of the slip stream may be controlled and/or regulated, such as to control and/or regulate the pressure within enclosed volume 32 and/or to control and/or regulate pressure force 196 that retains vacuum-mount tool 20 on surface 14.

As an example, vacuum-mount tool 20 may include a flow-regulating structure 138, which may be configured to control and/or regulate the flow rate of the slip stream into enclosed volume 32 and/or to control and/or regulate the flow rate of any other stream that enters and/or exits enclosed volume 32. Examples of flow-regulating structure 138 include a valve, a check valve, and/or a pressure regulator.

As illustrated in dashed lines in FIG. 1 and in solid lines in FIGS. 2-4 and 6, vacuum-mount tool 20 may include a translation structure 160. Translation structure 160 may be configured to permit and/or facilitate translation, or operative translation, of vacuum-mount tool 20 across surface 14. As an example, translation structure 160 may include and/or be a handle 162, which may be external enclosed volume 32 and/or may be configured to be gripped by the operator of vacuum-mount tool 20 to facilitate manual translation, or navigation, of vacuum-mount tool 20 across surface 14. In some examples, handle 162 may be directly attached to vacuum-mount tool 20. In some examples, handle 162 may include a pole and/or other extension, which may increase a reach of the operator of vacuum-mount tool 20. In some examples, handle 162 may be connected to a robot and/or another machine, which may be utilized to move vacuum-mount tool 20 in an automated fashion.

As another example, translation structure 160 may include a plurality of rollers 164. Rollers 164 may be configured to contact surface 14 and/or to facilitate operative translation of vacuum-mount tool 20 across surface 14, such as via decreasing frictional forces between vacuum-mount tool 20 and surface 14. Rollers 164 may be configured to set and/or to maintain a precise, a predetermined, and/or a defined distance between surface 14 and at least one component of vacuum-mount tool 20, such as enclosure 30, sealing structure 40, and/or device mount 80.

As yet another example, vacuum-mount tool 20 may include a plurality of actuators 166. Actuators 166 may be configured to selectively power and/or rotate rollers 164 to translate, to automatically translate, and/or to electrically translate vacuum-mount tool 20 across surface 14. In such an example, rollers 164 may include and/or be omni-directional Mecanum wheels. Examples of actuators 166 include motors, electric motors, servo motors, and/or stepper motors.

In some such examples, vacuum-mount tool 20 may include and/or may be in communication with a controller 168. Controller 168 may be adapted, configured, and/or programmed to selectively actuate rollers 164, such as via actuation of actuators 166, to automatically direct vacuum-mount tool 20 across surface 14, such as along a predetermined tool trajectory across surface 14.

In some examples, controller 168 may include and/or may be in communication with one or more sensors 170. Sensors 170 may be configured to establish, to quantify, and/or to determine one or more properties of vacuum-mount tool 20, such as a location and/or position of vacuum-mount tool 20 on surface 14, a velocity of vacuum-mount tool 20 relative to surface 14, an acceleration of vacuum-mount tool 20 relative to surface 14, and/or one or more characteristics of surface 14 subsequent to the device operation being performed on surface 14. Examples of sensors 170 include a camera, a distance measurement device, a laser distance measurement device, a velocimeter, an accelerometer, and/or a metrology tool that is configured to quantify the one or more characteristics of surface 14. In some such examples, controller 168 may determine, specify, and/or adjust the trajectory of vacuum-mount tool 20 across surface 14, the velocity of vacuum-mount tool 20, the acceleration of vacuum-mount tool 20, and/or one or more characteristics of the device operation responsive to and/or based upon information obtained from sensors 170.

In a specific example, sensors 170 may include a camera, or a short focal length camera, that may be positioned within enclosed volume 32. In such a configuration, the camera may be utilized to identify various structure(s) associated with surface 14, such as rivet heads on surface 14, and/or to quantify removal of paint from surface 14 during a sanding operation and/or during a laser ablation operation. In another specific example, sensors 170 may include an acoustic sensor and/or an optical sensor, each of which may be utilized to provide additional information regarding the device operation, such as, for example, the effectiveness of the laser ablation operation. In another specific example, sensors 170 may include a film thickness measurement device, which may be configured to measure a thickness of paint and/or another film on surface 14. Such a configuration may permit controller 168 to select a velocity for vacuum-mount tool across surface 14, such as may be sufficiently slow to permit vacuum-mount tool 20 to effectively perform the device operation on surface 14.

Surface 14 may include and/or be any suitable surface to which vacuum-mount tool 20 may be selectively and/or temporarily urged toward and/or attached via evacuation of enclosed volume 32 and/or via pressure force 196. In some examples, surface 14 may include a fluid-impermeable, or an at least substantially fluid-impermeable, surface 14. In some examples, surface 14 may be a surface of a structure 10, such as an aircraft 12.

FIG. 7 is a flowchart depicting examples of methods 200 of utilizing a vacuum-mount tool to perform a device operation on a surface, according to the present disclosure. Methods 200 include positioning the vacuum-mount tool at 210 and applying an applied vacuum at 220. Methods 200 also may include adjusting a position of a device at 230 and/or biasing the device at 240 and include performing the device operation at 250. Methods 200 further may include providing a slip stream at 260, moving the vacuum-mount tool at 270, and/or repeating at least a subset of the methods at 280.

Positioning the vacuum-mount tool at 210 may include positioning the vacuum-mount tool on the surface. The vacuum-mount tool includes the device and an enclosure, and, subsequent to the positioning, the enclosure and the surface together define an enclosed volume. The device is positioned at least partially, or even completely, within the enclosed volume, and the positioning further includes forming an at least partial fluid seal between the surface and a sealing structure of the device.

The positioning at 210 may be accomplished in any suitable manner. As an example, the positioning at 210 may include manually positioning the vacuum-mount tool on the surface, such as by an operator of the vacuum-mount tool. As another example, the positioning at 210 may include automatically positioning the vacuum-mount tool on the surface, such as utilizing a translation structure of the vacuum-mount tool. Examples of the vacuum-mount tool, including components thereof, are disclosed herein with reference to vacuum-mount tool 20. Examples of the surface are disclosed herein with reference to surface 14. Examples of the device, the enclosure, the enclosed volume, and the sealing structure are disclosed herein with reference to device 180, enclosure 30, enclosed volume 32, and sealing structure 40, respectively.

The positioning at 210 may be performed with any suitable timing and/or sequence during methods 200. As examples, the positioning at 210 may be performed prior to, at least partially concurrently with, and/or during the applying at 220, the adjusting at 230, the biasing at 240, the performing at 250, the providing at 260, the moving at 270, and/or the repeating at 280.

Applying the applied vacuum at 220 may include applying the applied vacuum to the enclosed volume. This may include applying the applied vacuum to at least partially evacuate the enclosed volume and/or to generate a pressure force that attaches the vacuum-mount tool to the surface and/or that urges the vacuum-mount tool toward and/or onto the surface.

The applying at 220 may be performed in any suitable manner. As an example, the applying at 220 may include applying the applied vacuum with, via, and/or utilizing a vacuum source that may be attached to, may form a portion of, and/or may be in vacuum communication with the vacuum-mount tool. Examples of the vacuum source are disclosed herein with reference to vacuum source 190.

The applying at 220 may be performed with any suitable timing and/or sequence during methods 200. As an example, the applying at 220 may be performed subsequent to the positioning at 210, the adjusting at 230, and/or the biasing at 240. As additional examples, the applying at 220 may be performed prior to, at least partially concurrently with, and/or during the adjusting at 230, the biasing at 240, the performing at 250, the providing at 260, the moving at 270, and/or the repeating at 280.

Adjusting the position of the device at 230 may include adjusting the position of the device within the enclosure, relative to an enclosure opening of the enclosure, and/or relative to the surface. This may include operatively translating the device, within the enclosure, relative to the enclosure opening, and/or relative to the surface such that there is a desired distance between the device and the surface, such that the device touches the surface, and/or such that the device applies a desired contact force to the surface.

The adjusting at 230 may be performed in any suitable manner. As an example, the adjusting at 230 may be performed with, via, and/or utilizing a height adjustment structure of the vacuum-mount tool and/or utilizing a device biasing structure of the vacuum-mount tool. Examples of the height adjustment structure and the device biasing structure are disclosed herein with reference to height adjustment structure 100 and device biasing structure 110, respectively.

The adjusting at 230 may be performed with any suitable timing and/or sequence during methods 200. As examples, the adjusting at 230 may be performed subsequent to the positioning at 210, the applying at 220, and/or the biasing at 240. As additional examples, the adjusting at 230 may be performed prior to, at least partially concurrently with, and/or during the positioning at 210, the applying at 220, the biasing at 240, the performing at 250, the providing at 260, the moving at 270, and/or the repeating at 280.

Biasing the device at 240 may include biasing the device toward and/or into contact with the surface. This may include maintaining a constant, or at least substantially constant, distance between the device and the surface and/or contact force between the device and the surface.

The biasing at 240 may be performed in any suitable manner. As an example, the biasing at 240 may be performed with, via, and/or utilizing a device biasing structure of the vacuum-mount tool.

The biasing at 240 may be performed with any suitable timing and/or sequence during methods 200. As examples, the biasing at 240 may be performed subsequent to the positioning at 210, the applying at 220, and/or the adjusting at 230. As additional examples, the biasing at 240 may be performed prior to, at least partially concurrently with, and/or during the applying at 220, the adjusting at 230, the performing at 250, the providing at 260, the moving at 270, and/or the repeating at 280.

Performing the device operation at 250 may include performing the device operation on the surface and/or with the device. This may include performing the device operation while the enclosed volume is evacuated by the applied vacuum and/or while the pressure force urges the vacuum-mount tool toward the surface.

The device operation may include any suitable device operation, which may be performed by any suitable device. Examples of the device operation are disclosed herein and include sanding the surface utilizing the device, laser ablating the surface utilizing the device, washing the surface utilizing the device, printing on the surface utilizing the device, inspecting the surface utilizing the device, and/or painting the surface utilizing the device. In some examples, methods 200 may include pivoting the device relative to the enclosure and/or about a pivot point. Such pivoting, when performed during the performing at 250, may permit and/or facilitate improved contact between the device and the surface, more consistent contact between the device and the surface, a more consistent contact force between the device and the surface, and/or a more consistent distance between the device and the surface. This may especially be true during the moving at 270 and/or when the surface is an arcuate, curved, non-flat, and/or non-planar surface.

The performing at 250 may be performed with any suitable timing and/or sequence during methods 200. As examples, the performing at 250 may be performed subsequent to the positioning at 210, the applying at 220, the adjusting at 230, and/or the biasing at 240. As additional examples, the performing at 250 may be performed prior to, at least partially concurrently with, and/or during the providing at 260, the moving at 270, and/or the repeating at 280.

Providing the slip stream at 260 may include providing any suitable slip stream into the enclosed volume. This may include providing the slip stream to regulate, or to selectively regulate a magnitude of the pressure force, such as to permit and/or facilitate the moving at 270. Stated differently, the providing at 260 may include regulating, or selectively regulating, a flow rate of the slip stream, such as to regulate the magnitude of the pressure force.

The providing at 260 may be performed in any suitable manner. As an example, the providing at 260 may include regulating the flow rate of the slip stream with, via, and/or utilizing a flow-regulating structure, examples of which are disclosed herein with reference to flow-regulating structure 138.

The providing at 260 may be performed with any suitable timing and/or sequence during methods 200. As examples, the providing at 260 may be performed subsequent to the positioning at 210, the applying at 220, the adjusting at 230, and/or the biasing at 240. As additional examples, the providing at 260 may be performed prior to, at least partially concurrently with, and/or during the positioning at 210, the applying at 220, the adjusting at 230, the biasing at 240, the performing at 250, the moving at 270, and/or the repeating at 280.

Moving the vacuum-mount tool at 270 may include moving the vacuum-mount tool on and/or across the surface. Stated differently, the performing at 250 initially may include performing the device operation at an initial location on the surface, and the moving at 270 may permit and/or facilitate performance of the device operation at a plurality of locations on the surface, on a threshold fraction of a surface area of the surface, and/or on an entirety of the surface.

The moving at 270 may be accomplished in any suitable manner. As an example, the moving at 270 may include manually moving the vacuum-mount tool, such as by the operator of the vacuum-mount tool. As another example, the moving at 270 may include automatically and/or autonomously moving the vacuum-mount tool, such as by utilizing a translation structure of the vacuum-mount tool, a plurality of actuators of the vacuum-mount tool, and/or a controller programmed to control motion of the vacuum-mount tool across the surface. Examples of the translation structure, the plurality of actuators, and the controller are disclosed herein with reference to translation structure 160, actuators 166, and controller 168, respectively.

The moving at 270 may be performed with any suitable timing and/or sequence during methods 200. As examples, the moving at 270 may be performed subsequent to the positioning at 210, the applying at 220, the adjusting at 230, the biasing at 240, and/or the performing at 250. As additional examples, the moving at 270 may be performed prior to, at least partially concurrently with, and/or during the performing at 250, the providing at 260, and/or the repeating at 280.

Repeating at least a subset of the methods at 280 may include repeating any suitable step and/or steps of methods 200 in any suitable order and/or for any suitable purpose. As an example, the device may be a first device, which is configured to perform a first device operation on the surface. In such a configuration, methods 200 initially may include performing the first device operation on the surface utilizing the first device. Subsequently, the repeating at 280 may include ceasing the applying at 220, separating the first device from a remainder of the vacuum-mount tool, operatively attaching a second device, which is configured to perform a second device operation that differs from the first device operation, to the remainder of the tool, and repeating at least the positioning at 210, the applying a 220, and the performing at 250 to perform the second device operation on the surface. In such a configuration, the performing the first device operation and/or the performing the second device operation also may include one or more of performing the adjusting at 230, performing the biasing at 240, performing the providing at 260, and/or performing the moving at 270.

Illustrative, non-exclusive examples of inventive subject matter according to the present disclosure are described in the following enumerated paragraphs:

A1. A vacuum-mount tool (20) configured to be utilized on a surface (14), the vacuum-mount tool (20) comprising:
an enclosure (30) that defines a enclosure opening (34);
a sealing structure (40) that defines a surface-contacting seal (44), wherein the sealing structure (40) is operatively attached to the enclosure (30) such that, when the surface-contacting seal (44) is brought into sealing engagement with the surface (14), the surface (14) covers the enclosure opening (34) such that the enclosure (30), the sealing structure (40), and the surface (14) together define an enclosed volume (32);
a vacuum inlet port (70) that extends from external the enclosure (30) into the enclosed volume (32), wherein the vacuum inlet port (70) is configured to receive an applied vacuum (194) that selectively urges the vacuum-mount tool (20) toward the surface (14), or that selectively attaches the vacuum-mount tool (20) to the surface (14) via a pressure force (196) generated by evacuation of the enclosed volume (32); and
a device mount (80) positioned within the enclosed volume (32) and configured to retain a device (180) within the enclosed volume (32), wherein the device (180) is configured to perform a device operation on the surface (14) via the enclosure opening (34).

A2. The vacuum-mount tool (20) of paragraph A1, wherein the enclosure (30) is shaped to bound a majority of the enclosed volume (32).

A3. The vacuum-mount tool (20) of any of paragraphs A1-A2, wherein the enclosure (30) is shaped to at least partially bound at least one of:
(i) five sides of the enclosed volume (32); and
(ii) all but one side of the enclosed volume (32).

A4. The vacuum-mount tool (20) of any of paragraphs A1-A3, wherein, when the sealing structure (40) is brought into sealing engagement with the surface (14), the enclosure (30), the sealing structure (40), and the surface (14) together define at least one of a rectangular, an at least partially rectangular, an at least partially circular, a cylindrical, an at least partially cylindrical, and an at least partially elliptical enclosed volume (32).

A5. The vacuum-mount tool (20) of any of paragraphs A1-A4, wherein the sealing structure (40) includes at least one of an elastomeric sealing structure, a resilient sealing structure, and a polymeric sealing structure.

A6. The vacuum-mount tool (20) of any of paragraphs A1-A5, wherein the sealing structure (40) includes, or is, a resilient sealing skirt (46) configured to conform to a surface shape of the surface (14), optionally wherein the resilient sealing skirt (46) extends from the enclosure opening (34).

A7. The vacuum-mount tool (20) of any of paragraphs A1-A6, wherein the sealing structure (40) includes, or is, a resilient sealing lip (42) configured to conform to a/the surface shape of the surface (14), optionally wherein the resilient sealing lip (42) at least one of extends from a/the resilient sealing skirt (46) and extends from the enclosure opening (34).

A8. The vacuum-mount tool (20) of any of paragraphs A1-A7, wherein the vacuum-mount tool (20) further includes a sealing structure support frame (60) configured to support the sealing structure (40) relative to the enclosure (30).

A9. The vacuum-mount tool (20) of paragraph A8, wherein the sealing structure support frame (60) includes a plurality of support frame biasing members (62) configured to bias the surface-contacting seal (44) away from the enclosure opening (34).

A10. The vacuum-mount tool (20) of paragraph A9, wherein the plurality of support frame biasing members (62) includes at least one of a plurality of resilient support frame biasing members and a plurality of support frame biasing springs.

A11. The vacuum-mount tool (20) of any of paragraphs A9-A10, wherein each support frame biasing member (62) of the plurality of support frame biasing members (62) is configured to independently bias a corresponding region of the sealing structure (40) away from the enclosure opening (34) to permit the surface-contacting seal (44) to conform to a/the surface shape of the surface (14).

A12. The vacuum-mount tool (20) of any of paragraphs A1-A11, wherein the vacuum inlet port (70) includes a vacuum conduit mount (72) configured to be operatively attached to a vacuum conduit (192) configured to provide the applied vacuum (194).

A13. The vacuum-mount tool (20) of paragraph A12, wherein the vacuum-mount tool (20) further includes the vacuum conduit (192).

A14. The vacuum-mount tool (20) of any of paragraphs A1-A13, wherein the vacuum-mount tool (20) further includes a vacuum source (190) configured to provide the applied vacuum (194) to the enclosed volume (32), optionally via a/the vacuum conduit (192).

A15. The vacuum-mount tool (20) of any of paragraphs A1-A14, wherein the vacuum inlet port (70) further is configured to receive a waste material (16), which is generated by the device operation, from the enclosed volume (32).

A16. The vacuum-mount tool (20) of paragraph A15, wherein the waste material (16) includes at least one of a liquid waste material, a solid waste material, and a particulate waste material.

A17. The vacuum-mount tool (20) of any of paragraphs A15-A16, wherein the waste material (16) includes debris removed from the surface (14) via the device operation.

A18. The vacuum-mount tool (20) of any of paragraphs A1-A17, wherein the device mount (80) is a modular device mount (80) configured to retain a plurality of different devices (180) within the enclosed volume (32).

A19. The vacuum-mount tool (20) of paragraph A18, wherein the modular device mount (80) includes a device adapter (84), which is configured to be operatively attached to a corresponding device (180) of the plurality of devices (180), and an adapter mount (82), which is configured to operatively attach the device adapter (84) to the enclosure (30).

A20. The vacuum-mount tool (20) of paragraph A19, wherein the vacuum-mount tool (20) includes a plurality of distinct device adapters (84), wherein each device adapter (84) in the plurality of distinct device adapters (84) is configured to be operatively attached to a different corresponding device (180) of the plurality of devices (180).

A21. The vacuum-mount tool (20) of any of paragraphs A1-A20, wherein the device mount (80) includes a pivot structure (90) configured to permit the device (180) to pivot about a pivot point (92), relative to the enclosure (30), within the enclosed volume (32).

A22. The vacuum-mount tool (20) of paragraph A21, wherein the pivot structure (90) includes a spherical, or at least partially spherical, bearing.

A23. The vacuum-mount tool (20) of any of paragraphs A21-A22, wherein the pivot structure (90) operatively attaches a remainder of the device mount (80) to the enclosure (30).

A24. The vacuum-mount tool (20) of any of paragraphs A1-A23, wherein the device mount (80) includes a height adjustment structure (100) configured to operatively translate the device (180) relative to the enclosure opening (34).

A25. The vacuum-mount tool (20) of paragraph A24, wherein the height adjustment structure (100) is configured to selectively adjust a position of the device (180) relative to the enclosure opening (34).

A26. The vacuum-mount tool (20) of paragraph A25, wherein the height adjustment structure (100) includes a height adjustment handle (102), which is positioned external the enclosed volume (32), optionally wherein the height adjustment handle (102) is configured to be rotated to selectively adjust the position of the device (180) relative to the enclosure opening (34).

A27. The vacuum-mount tool (20) of any of paragraphs A24-A26, wherein the height adjustment structure (100) includes a threaded post (104) and a threaded nut (106).

A28. The vacuum-mount tool (20) of paragraph A27, wherein the threaded post (104) is configured to be operatively attached to at least one of the device (180) and an/the adapter mount (82).

A29. The vacuum-mount tool (20) of any of paragraphs A27-A28, wherein the threaded post (104) is configured to operatively attach the device (180) to a remainder of the vacuum-mount tool (20).

A30. The vacuum-mount tool (20) of any of paragraphs A27-A29, wherein the threaded post (104) is configured to be rotated to operatively translate the device (180) relative to the enclosure opening (34).

A31. The vacuum-mount tool (20) of any of paragraphs A27-A30, wherein the threaded post (104) is operatively attached to a/the remainder of the vacuum-mount tool (20) via the threaded nut (106).

A32. The vacuum-mount tool (20) of any of paragraphs A27-A31, wherein the threaded nut (106) at least one of at least partially defines and is operatively attached to a/the pivot structure (90) configured to permit the device (180) to pivot about a pivot point (92), relative to the enclosure (30), within the enclosed volume (32).

A33. The vacuum-mount tool (20) of paragraph A32, wherein the pivot point (92) is within the threaded nut (106).

A34. The vacuum-mount tool (20) of any of paragraphs A1-A33, wherein the device mount (80) further includes a device biasing structure (110) configured to bias the device (180) at least one of toward and into the enclosure opening (34), optionally wherein the device biasing structure (110) is configured to be actuated to selectively bias the device (180) at least one of toward and into the enclosure opening (34).

A35. The vacuum-mount tool (20) of paragraph A34, wherein the device biasing structure (110) is configured to provide a constant, or at least substantially constant, contact force between the device (180) and the surface (14).

A36. The vacuum-mount tool (20) of any of paragraphs A34-A35, wherein the device biasing structure (110) includes at least one of a resilient biasing member, an air bearing, and a pneumatic cylinder.

A37. The vacuum-mount tool (20) of any of paragraphs A1-A36, wherein the device (180) is a powered device configured to receive a motive input (126) and to perform the device operation on the surface (14) responsive to receipt of the motive input (126).

A38. The vacuum-mount tool (20) of paragraph A37, wherein the motive input (126) includes at least one of an electric motive input, a pneumatic motive input, and a hydraulic motive input.

A39. The vacuum-mount tool (20) of any of paragraphs A37-A38, wherein the vacuum-mount tool (20) further includes a motive input supply structure (124) configured to receive the motive input (126) from external the enclosed volume (32) and to convey the motive input (126) into the enclosed volume (32) to provide the motive input (126) to the device (180).

A40. The vacuum-mount tool (20) of paragraph A39, wherein the motive input supply structure (124) includes at least one of an electrical conduit and a fluid conduit.

A41. The vacuum-mount tool (20) of any of paragraphs A39-A40, wherein the motive input supply structure (124) is configured to maintain a fixed, or at least substantially fixed, orientation relative to a/the device mount (80) when the device mount (80) pivots relative to the enclosure (30) and about a/the pivot point (92).

A42. The vacuum-mount tool (20) of any of paragraphs A39-A41, wherein the motive input supply structure (124) is operatively attached to the enclosure (30) via a resilient supply attachment structure (122) configured to permit the motive input supply structure (124) to pivot relative to the enclosure (30) and about a/the pivot point (92).

A43. The vacuum-mount tool (20) of any of paragraphs A39-A42, wherein the vacuum-mount tool (20) further includes a motive input discharge structure (128) configured to receive the motive input (126) from the device (180) and convey the motive input (126) external the enclosed volume (32).

A44. The vacuum-mount tool (20) of paragraph A43, wherein the motive input discharge structure (128) includes a motive input discharge fluid conduit.

A45. The vacuum-mount tool (20) of any of paragraphs A43-A44, wherein the motive input discharge structure (128) is operatively attached to the enclosure (30) via a/the resilient supply attachment structure (122).

A46. The vacuum-mount tool (20) of any of paragraphs A1-A45, wherein the vacuum-mount tool (20) further includes a motive input source (120) configured to provide the motive input (126) to the motive input supply structure (124).

A47. The vacuum-mount tool (20) of paragraph A46, wherein the motive input source (120) includes at least one of an electric current source, a pressurized air source, and a pressurized liquid source.

A48. The vacuum-mount tool (20) of any of paragraphs A1-A47, wherein the vacuum-mount tool (20) includes the device (180).

A49. The vacuum-mount tool (20) of any of paragraphs A1-A48, wherein the device (180) includes, or is, a sanding device configured to perform a sanding operation on the surface (14).

A50. The vacuum-mount tool (20) of paragraph A49, wherein the enclosure (30) is configured to contain debris generated during the sanding operation.

A51. The vacuum-mount tool (20) of paragraph A50, wherein the vacuum-mount tool (20) further is configured to discharge the debris via the vacuum inlet port (70).

A52. The vacuum-mount tool (20) of any of paragraphs A49-A51, wherein the sanding device is a pneumatically powered sanding device.

A53. The vacuum-mount tool (20) of any of paragraphs A1-A52, wherein the device (180) includes, or is, a laser ablation device that includes a laser configured to direct a laser beam incident upon the surface (14) and to perform a laser ablation operation on the surface (14) utilizing the laser beam.

A54. The vacuum-mount tool (20) of paragraph A53, wherein the enclosure (30) is configured to contain debris generated during the laser ablation operation.

A55. The vacuum-mount tool (20) of paragraph A54, wherein the vacuum-mount tool (20) further is configured to discharge the debris from the enclosed volume (32) via the vacuum inlet port (70).

A56. The vacuum-mount tool (20) of any of paragraphs A53-A55, wherein the vacuum-mount tool (20) further includes a compressed air inlet port (132) configured to direct a compressed air stream between the laser and the surface (14) remove debris from a beam path of the laser beam.

A57. The vacuum-mount tool (20) of any of paragraphs A53-A56, wherein the vacuum-mount tool (20) further includes a vacuum detection structure (150) configured to cease emission of the laser beam from the laser responsive to a pressure within the enclosed volume (32) being greater than a threshold pressure.

A58. The vacuum-mount tool (20) of any of paragraphs A1-A57, wherein the device (180) includes, or is, a cleaning device configured to perform a cleaning operation on the surface (14).

A59. The vacuum-mount tool (20) of paragraph A58, wherein the cleaning device is configured to direct a water stream incident upon the surface (14).

A60. The vacuum-mount tool (20) of paragraph A59, wherein the vacuum-mount tool (20) further includes a water inlet port (134) configured to convey the water stream into the enclosed volume (32).

A61. The vacuum-mount tool (20) of any of paragraphs A59-A60, wherein the vacuum-mount tool (20) further is configured to discharge the water stream from the enclosed volume (32) via the vacuum inlet port (70).

A62. The vacuum-mount tool (20) of any of paragraphs A1-A61, wherein the device (180) includes, or is, a printing device configured to perform a printing operation on the surface (14).

A63. The vacuum-mount tool (20) of paragraph A62, wherein the printing device includes, or is, an inkjet printer.

A64. The vacuum-mount tool (20) of any of paragraphs A1-A63, wherein the device (180) includes, or is, an inspection device configured to perform an inspection operation on the surface (14). A65. The vacuum-mount tool (20) of any of paragraphs A1-A64, wherein the device (180) includes, or is, a painting device configured to paint the surface (14).

A66. The vacuum-mount tool (20) of paragraph A65, wherein the vacuum-mount tool (20) further includes a paint inlet port (136) configured to convey paint into the enclosed volume (32).

A67. The vacuum-mount tool (20) of any of paragraphs A1-A66, wherein the vacuum-mount tool (20) further includes a slip stream inlet port (130) configured to provide a slip stream into the enclosed volume (32), optionally wherein the slip stream includes at least one of a gas, a compressed gas, compressed air, and ambient air.

A68. The vacuum-mount tool (20) of paragraph A67, wherein the slip stream inlet port (130) at least one of:
(i) is distinct from a/the motive inlet supply structure (124); and
(ii) includes, or is, the motive inlet supply structure (124).

A69. The vacuum-mount tool (20) of any of paragraphs A67-A68, wherein the vacuum-mount tool (20) further includes a flow-regulating structure (138) configured to regulate a flow rate of the slip stream into the enclosed volume (32), optionally to at least one of:
(i) regulate a magnitude of the pressure force (196); and
(ii) convey debris from the enclosed volume (32) via the vacuum inlet port (70).

A70. The vacuum-mount tool (20) of paragraph A69, wherein the flow-regulating structure (138) includes at least one of a valve, a check valve, and a pressure regulator.

A71. The vacuum-mount tool (20) of any of paragraphs A1-A70, wherein the vacuum-mount tool (20) further includes a translation structure (160) configured to facilitate operative translation of the vacuum-mount tool (20) across the surface (14).

A72. The vacuum-mount tool (20) of paragraph A71, wherein the translation structure (160) includes, or is, a handle (162) that is external the enclosed volume (32) and configured to be gripped, by an operator of the vacuum-mount tool (20), to facilitate manual translation of the vacuum-mount tool (20) across the surface (14).

A73. The vacuum-mount tool (20) of any of paragraphs A71-A72, wherein the translation structure (160) includes, or is, a plurality of rollers (164) that contacts the surface (14) and facilitates operative translation of the vacuum-mount tool (20) across the surface (14).

A74. The vacuum-mount tool (20) of paragraph A73, wherein the vacuum-mount tool (20) further includes a plurality of actuators (166) configured to selectively rotate the plurality of rollers (164).

A75. The vacuum-mount tool (20) of paragraph A74, wherein the vacuum-mount tool (20) further includes a controller (168) programmed to selectively actuate the plurality rollers (164), via the plurality of actuators (166), to autonomously direct the vacuum-mount tool (20) across the surface (14) along a predetermined tool trajectory.

B1. A method (200) of utilizing a vacuum-mount tool (20) to perform a device operation on a surface (14), the method (200) comprising:
positioning (210) the vacuum-mount tool (20), which includes a device (180), on the surface (14), wherein the vacuum-mount tool (20) includes an enclosure (30), wherein the enclosure (30) and the surface (14) together define an enclosed volume (32), wherein the device (180) is positioned at least partially within the enclosed volume (32), and further wherein the positioning (210) includes forming an at least partial fluid seal between the surface (14) and a sealing structure (40) of the device (180);
applying (220) an applied vacuum (194) to the enclosed volume (32) to at least partially evacuate the enclosed volume (32) and generate a pressure force (196) that urges the vacuum-mount tool (20) toward the surface (14), or that selectively attaches the vacuum-mount tool (20) to the surface (14); and
performing (250) the device operation on the surface (14) with the device (180) while the pressure force (196) urges the vacuum-mount tool (20) toward the surface (14) or attaches the vacuum-mount tool (20) to the surface (14).

B2. The method (200) of paragraph B1, wherein, during the performing (150) the device operation on the surface (14), the method (200) further includes moving (270) the vacuum-mount tool (20) across the surface (14).

B3. The method (200) of paragraph B2, wherein the moving (270) includes manually moving by an operator of the vacuum-mount tool (20).

B4. The method (200) of any of paragraphs B2-B3, wherein the moving (270) includes autonomously moving utilizing a plurality of actuators (166) of the vacuum-mount tool (20).

B5. The method (200) of any of paragraphs B1-B4, wherein, during the performing (250) the device operation, the method (200) further includes providing (260) a slip stream into the enclosed volume (32) to selectively regulate a magnitude of the pressure force (196), optionally to facilitate a/the moving (270) the vacuum-mount tool (20) across the surface (14).

B6. The method (200) of any of paragraphs B1-B5, wherein the device (180) is a first device (180), wherein the device operation is a first device operation, and further wherein, subsequent to the performing (250) the device operation on the surface (14), the method (200) further includes:
(i) ceasing the applying (220) the applied vacuum (194);
(ii) separating the first device (180) from a remainder of the vacuum-mount tool (20);
(iii) operatively attaching a second device (180), which is configured to perform a second device operation that differs from the first device operation, to the remainder of the vacuum-mount tool (20); and
(iv) repeating (280) the positioning (210), the applying (220), and the performing (250) to perform the second device operation on the surface (14).

B7. The method (200) of paragraph B6, wherein the separating and the operatively attaching include utilizing a modular device mount (80) of the vacuum-mount tool (20).

B8. The method (200) of any of paragraphs B1-B7, wherein, during the performing (250) the device operation, the method (200) further includes pivoting the device (180) relative to the enclosure (30) about a pivot point (92).

B9. The method (200) of any of paragraphs B1-B8, wherein the method (200) further includes adjusting (230) a position of the device (180) relative to an enclosure opening (34) of the enclosure (30) utilizing a device translation structure (160) of the vacuum-mount tool (20).

B10. The method (200) of any of paragraphs B1-B9, wherein, during the performing (250) the device operation, the method (200) further includes biasing (240) the device (180) toward the surface (14) utilizing a device biasing structure (110) of the vacuum-mount tool (20).

B11. The method (200) of paragraph B10, wherein the biasing (240) includes maintaining a constant, or at least substantially constant, contact force between the device (180) and the surface (14).

B12. The method (200) of any of paragraphs B1-B11, wherein the performing (250) the device operation includes at least one of:
(i) sanding the surface (14) utilizing the device (180);
(ii) laser ablating the surface (14) utilizing the device (180);
(iii) washing the surface (14) utilizing the device (180);
(iv) printing on the surface (14) utilizing the device (180);
(v) inspecting the surface (14) utilizing the device (180); and
(vi) painting the surface (14) utilizing the device (180).

B13. The method (200) of any of paragraphs B1-B12, wherein the vacuum-mount tool (20) includes any suitable structure, function, and/or feature of any of the vacuum-mount tools (20) of any of paragraphs A1-A75.

As used herein, the terms “selective” and “selectively,” when modifying an action, movement, configuration, or other activity of one or more components or characteristics of an apparatus, mean that the specific action, movement, configuration, or other activity is a direct or indirect result of user manipulation of an aspect of, or one or more components of, the apparatus.

As used herein, the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa. Similarly, subject matter that is recited as being configured to perform a particular function may additionally or alternatively be described as being operative to perform that function.

As used herein, the phrase “at least one,” in reference to a list of one or more entities should be understood to mean at least one entity selected from any one or more of the entity in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C” and “A, B, and/or C” may mean A alone, B alone, C alone, A and B together, A and C together, B and C together, A, B, and C together, and optionally any of the above in combination with at least one other entity.

The various disclosed elements of apparatuses and steps of methods disclosed herein are not required to all apparatuses and methods according to the present disclosure, and the present disclosure includes all novel and non-obvious combinations and subcombinations of the various elements and steps disclosed herein. Moreover, one or more of the various elements and steps disclosed herein may define independent inventive subject matter that is separate and apart from the whole of a disclosed apparatus or method. Accordingly, such inventive subject matter is not required to be associated with the specific apparatuses and methods that are expressly disclosed herein, and such inventive subject matter may find utility in apparatuses and/or methods that are not expressly disclosed herein.

As used herein, the phrase, “for example,” the phrase, “as an example,” and/or simply the term “example,” when used with reference to one or more components, features, details, structures, embodiments, and/or methods according to the present disclosure, are intended to convey that the described component, feature, detail, structure, embodiment, and/or method is an illustrative, non-exclusive example of components, features, details, structures, embodiments, and/or methods according to the present disclosure. Thus, the described component, feature, detail, structure, embodiment, and/or method is not intended to be limiting, required, or exclusive/exhaustive; and other components, features, details, structures, embodiments, and/or methods, including structurally and/or functionally similar and/or equivalent components, features, details, structures, embodiments, and/or methods, are also within the scope of the present disclosure.

As used herein, “at least substantially,” when modifying a degree or relationship, may include not only the recited “substantial” degree or relationship, but also the full extent of the recited degree or relationship. A substantial amount of a recited degree or relationship may include at least 75% of the recited degree or relationship. For example, an object that is at least substantially formed from a material includes objects for which at least 75% of the objects are formed from the material and also includes objects that are completely formed from the material. As another example, a first length that is at least substantially as long as a second length includes first lengths that are within 75% of the second length and also includes first lengths that are as long as the second length.

1. A vacuum-mount tool configured to be utilized on a surface, the vacuum-mount tool comprising:
an enclosure that defines a enclosure opening;
a sealing structure that defines a surface-contacting seal, wherein the sealing structure is operatively attached to the enclosure such that, when the surface-contacting seal is brought into sealing engagement with the surface, the surface covers the enclosure opening such that the enclosure, the sealing structure, and the surface together define an enclosed volume;
a vacuum inlet port that extends from external the enclosure into the enclosed volume, wherein the vacuum inlet port is configured to receive an applied vacuum that selectively urges the vacuum-mount tool toward the surface via a pressure force generated by evacuation of the enclosed volume; and
a device mount positioned within the enclosed volume and configured to retain a device within the enclosed volume, wherein the device is configured to perform a device operation on the surface via the enclosure opening.

2. The vacuum-mount tool of claim 1, wherein, when the sealing structure is brought into sealing engagement with the surface, the enclosure, the sealing structure, and the surface together define a rectangular, or at least partially rectangular, enclosed volume.

3. The vacuum-mount tool of claim 1, wherein the sealing structure includes at least one of an elastomeric sealing structure, a resilient sealing structure, and a polymeric sealing structure.

4. The vacuum-mount tool of claim 1, wherein the sealing structure includes a resilient sealing skirt configured to conform to a surface shape of the surface.

5. The vacuum-mount tool of claim 1, wherein the sealing structure includes a resilient sealing lip configured to conform to a surface shape of the surface.

6. The vacuum-mount tool of claim 1, wherein the vacuum-mount tool further includes a sealing structure support frame configured to support the sealing structure relative to the enclosure, wherein the sealing structure support frame includes a plurality of support frame biasing members configured to bias the surface-contacting seal away from the enclosure opening, and further wherein each support frame biasing member of the plurality of support frame biasing members is configured to independently bias a corresponding region of the sealing structure away from the enclosure opening to permit the surface-contacting seal to conform to a surface shape of the surface.

7. The vacuum-mount tool of claim 1, wherein the device mount is a modular device mount configured to retain a plurality of different devices within the enclosed volume, wherein the modular device mount includes a device adapter, which is configured to be operatively attached to a corresponding device of a plurality of devices, and an adapter mount, which is configured to operatively attach the device adapter to the enclosure.

8. The vacuum-mount tool of claim 1, wherein the device mount includes a pivot structure configured to permit the device to pivot about a pivot point, relative to the enclosure, within the enclosed volume.

9. The vacuum-mount tool of claim 1, wherein the device mount includes a height adjustment structure configured to operatively translate the device relative to the enclosure opening.

10. The vacuum-mount tool of claim 9, wherein the height adjustment structure includes a threaded post and a threaded nut, wherein the threaded post is configured to be operatively attached to the device, wherein the threaded post is configured to operatively attach the device to a remainder of the vacuum-mount tool, and wherein the threaded post is operatively attached to a remainder of the vacuum-mount tool via the threaded nut.

11. The vacuum-mount tool of claim 10, wherein the threaded nut at least one of at least partially defines and is operatively attached to a pivot structure configured to permit the device to pivot about a pivot point, relative to the enclosure, within the enclosed volume; wherein the pivot point is within the threaded nut.

12. The vacuum-mount tool of claim 1, wherein the device is a powered device configured to receive a motive input and to perform the device operation on the surface responsive to receipt of the motive input, wherein the vacuum-mount tool further includes a motive input supply structure configured to receive the motive input from external the enclosed volume and to convey the motive input into the enclosed volume to provide the motive input to the device.

13. The vacuum-mount tool of claim 12, wherein the motive input supply structure is operatively attached to the enclosure via a resilient supply attachment structure configured to permit the motive input supply structure to pivot relative to the enclosure and about a pivot point.

14. The vacuum-mount tool of claim 12, wherein the vacuum-mount tool further includes a motive input discharge structure configured to receive the motive input from the device and convey the motive input external the enclosed volume.

15. The vacuum-mount tool of claim 1, wherein the vacuum-mount tool includes the device, wherein the device includes a sanding device configured to perform a sanding operation on the surface, wherein the enclosure is configured to contain debris generated during the sanding operation, and further wherein the vacuum-mount tool further is configured to discharge the debris via the vacuum inlet port.

16. The vacuum-mount tool of claim 1, wherein the vacuum-mount tool includes the device, wherein the device includes a laser ablation device that includes a laser configured to direct a laser beam incident upon the surface and to perform a laser ablation operation on the surface utilizing the laser beam, wherein the enclosure is configured to contain debris generated during the laser ablation operation, wherein the vacuum-mount tool is configured to discharge the debris from the enclosed volume via the vacuum inlet port, and wherein the vacuum-mount tool further includes a vacuum detection structure configured to cease emission of the laser from the laser beam responsive to a pressure within the enclosed volume being greater than a threshold pressure.

17. The vacuum-mount tool of claim 1, wherein the vacuum-mount tool further includes a slip stream inlet port configured to provide a slip stream into the enclosed volume.

18. The vacuum-mount tool of claim 17, wherein the vacuum-mount tool further includes a flow-regulating structure configured to regulate a flow rate of the slip stream into the enclosed volume, to at least one of:
(i) regulate a magnitude of the pressure force; and
(ii) convey debris from the enclosed volume via the vacuum inlet port.

19. The vacuum-mount tool of claim 1, wherein the vacuum-mount tool further includes a translation structure configured to facilitate operative translation of the vacuum-mount tool across the surface.

20. A method of performing a device operation on a surface utilizing a device, the method comprising:
positioning a vacuum-mount tool, which includes the device, on the surface, wherein the vacuum-mount tool includes an enclosure that defines an enclosed volume, wherein the device is positioned at least partially within the enclosed volume, and further wherein the positioning includes forming an at least partial fluid seal between the surface and a sealing structure of the device;
applying an applied vacuum to the enclosed volume to at least partially evacuate the enclosed volume and generate a pressure force that urges the vacuum-mount tool toward the surface; and
performing the device operation on the surface with the device and while the pressure force urges the vacuum-mount tool toward the surface.
